(19) United States
(12) Patent Application Publication
(10) Pub. No.: US 2026/0012777 A1
(43) Pub. Date: Jan. 8, 2026

(54) INFORMATION PROCESSING METHOD, COMMUNICATION DEVICE, AND STORAGE MEDIUM

(71) Applicant: Beijing Xiaomi Mobile Software Co., Ltd., Beijing (CN)

(72) Inventor: Jinhua WU, Beijing (CN)

(73) Assignee: Beijing Xiaomi Mobile Software Co., Ltd., Beijing (CN)

(21) Appl. No.: 18/993,281

(22) PCT Filed: Jul. 12, 2022
(86) PCT No.: PCT/CN2022/105223

§ 371 Date: Jan. 10, 2025

(51) Int. Cl. H04W 8/24; H04W 4/38; H04W 60/00

(52) U.S. Cl. CPC H04W 8/24; H04W 4/38; H04W 60/00

(57) ABSTRACT

An information processing method, a communication device, and a storage medium are provided. The method includes: an AMF receives request information sent by UE via a base station, wherein the request information is configured to request for sensing service capability information of a network side.

### CROSS REFERENCE TO RELATED APPLICATIONS

The present disclosure is the U.S. national phase application of International Application No. PCT/CN2022/105223 filed on Jul. 12, 2022, the content of which is incorporated herein by reference in its entirety for all purposes.

### TECHNICAL FIELD

The present disclosure relates to but is not limited to, the field of communication technology, in particular, to an information processing method, an information processing apparatus, a communication device, and a storage medium.

### BACKGROUND

In cellular mobile communication technology, the mobile communication network can adopt an integrated communication sensing (synesthesia) scheme to integrate communication and sensing functions, enabling the communication system to have both communication and sensing functions simultaneously. By actively recognizing and analyzing the characteristics of the wireless channel while transmitting sensing information, one can perceive the physical features of the surrounding environment.

The integrated sensing and communication in cellular mobile communication systems means that sensing capabilities are provided by wireless communication systems and infrastructure used for communication, and sensing information can come from RF and/or non RF based sensors. Communication assisted sensing is involved in scenarios where 5G communication systems provide sensing services or sensing assisted communication. For example, sensing information associated with communication channels and environments is used to improve the communication services of the 5G system itself. For example, sensing information can be used to assist in radio resource management, interference mitigation, beam management, mobility, etc.

### SUMMARY

According to a first aspect of the present disclosure, an information processing method is provided. The information processing method is performed by an Access and Mobility Management Function (AMF), and includes:
receiving request information sent by user equipment (UE) via a base station, wherein the request information is configured to request for sensing service capability information of a network side.

According to a second aspect of the present disclosure, an information processing method is provided. The information processing method is performed by user equipment (UE), and includes:
sending request information to an Access and Mobility Management Function (AMF) via a base station, wherein the request information is configured to request for sensing service capability information of a network side.

According to a third aspect of the present disclosure, a communication device is provided. The communication device includes:
a processor;
   a memory for storing executable instructions that can be executed by the processor; wherein the processor is configured to execute the executable instructions to perform the information processing method described in the first aspect or the second aspect.

According to a fourth aspect of the present disclosure, a computer storage medium is

provided. The computer storage medium stores a computer executable program thereon, which when executed by a processor, the information processing method described in the first aspect or the second aspect is caused to be performed.

It should be understood that the general description in the above and the detailed description in the following are only exemplary and explanatory, and cannot limit embodiments of the present disclosure.

### BRIEF DESCRIPTION OF THE DRAWINGS

FIG. 1 is a schematic diagram of a structure of a wireless communication system according to one or more embodiments of the present disclosure.

FIG. 2 is a flowchart of an information processing method according to one or more embodiments of the present disclosure.

FIG. 3 is a flowchart of an information processing method according to one or more embodiments of the present disclosure.

FIG. 4 is a flowchart of an information processing method according to one or more embodiments of the present disclosure.

FIG. 5 is a flowchart of an information processing method according to one or more embodiments of the present disclosure.

FIG. 6 is a flowchart of an information processing method according to one or more embodiments of the present disclosure.

FIG. 7 is a flowchart of an information processing method according to one or more embodiments of the present disclosure.

FIG. 8 is a flowchart of an information processing method according to one or more embodiments of the present disclosure.

FIG. 11 is a block diagram of an information processing apparatus according to one or more embodiments of the present disclosure.

FIG. 10 is a block diagram of an information processing apparatus according to one or more embodiments of the present disclosure.

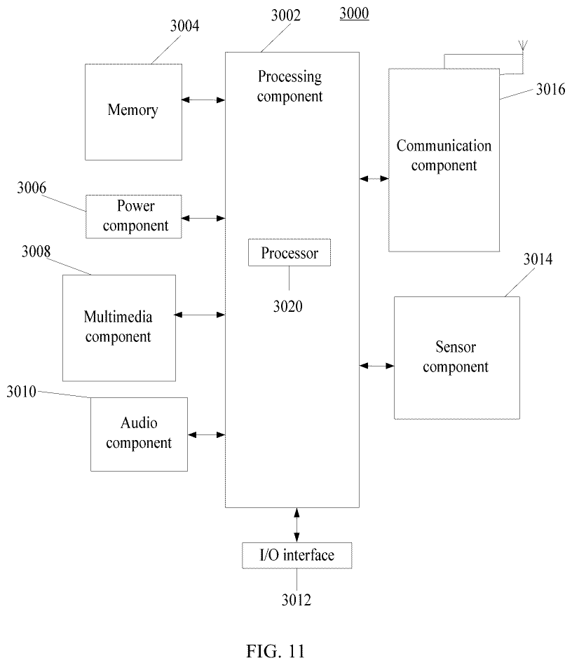

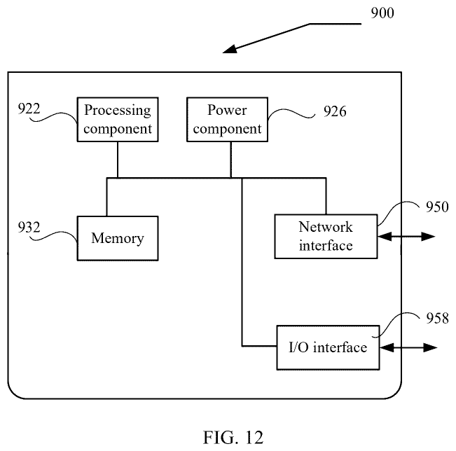

FIG. 11 is a block diagram of user equipment (UE) according to one or more embodiments of the present disclosure.

FIG. 12 is a block diagram of a base station according to one or more embodiments of the present disclosure.

### DETAILED DESCRIPTION

Detailed explanations of exemplary embodiments will be provided herein, with examples being illustrated in the drawings. The same reference numerals in different drawings represent the same or similar elements when the following description refers to the drawings unless otherwise indicated. The implementations described in the following exemplary embodiments do not represent all implementations consistent with the present disclosure. Instead, they are only examples of devices and methods consistent with some embodiments of the present disclosure described in the appended claims.

The terms used in embodiments of the present disclosure are for the purpose of description of specific embodiments only, and are not intended to limit the embodiments of the present disclosure. Singular forms such as “a,” and “the” used in the present disclosure and the appended claims are also intended to include plural forms, unless other meanings are clearly indicated in the context. It should also be understood that the term “and/or” used in the present disclosure refers to and includes any or all possible combinations of one or more listed items related.

It should be understood that although terms such as first, second, and third may be used to describe various information in embodiments of the present disclosure, such information should not be limited to these terms, which are only used to distinguish information of the same type from each other. For example, without departing from the scope of the present disclosure, the first information can also be referred to as the second information, and similarly, the second information can also be referred to as the first information. The word “if” used herein can be interpreted as “when,” “while,” or “in response to a determination that,” depending on the context.

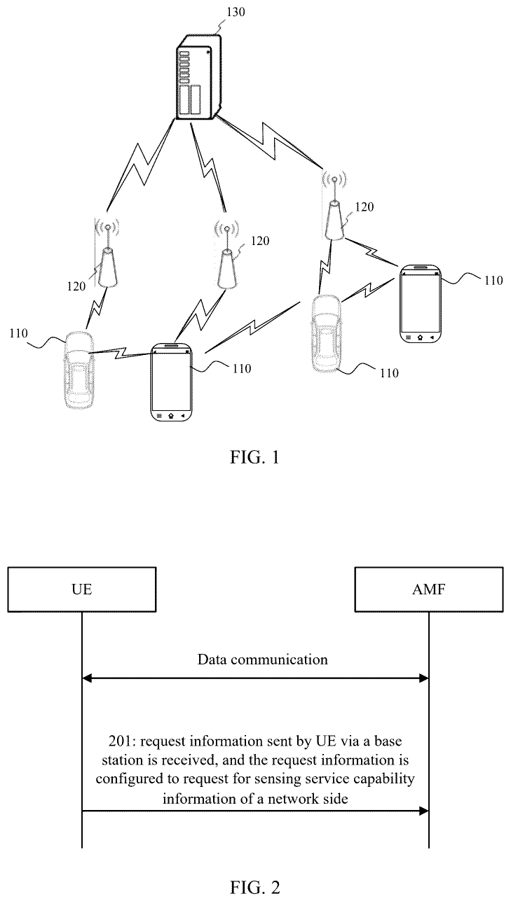

Reference is made to FIG. 1, which illustrates a schematic diagram of a structure of a wireless communication system provided by embodiments of the present disclosure. As shown in FIG. 1, the wireless communication system is a communication system based on cellular mobile communication technology, which can include several user equipment 110 and several base stations 120.

The user equipment 110 can be equipment that provides voice and/or data connectivity to a user. The user equipment 110 can communicate with one or more core networks via a Radio Access Network (RAN). The user equipment 110 can be an IoT (Internet of Things) terminal, for example, a sensor device, a mobile phone (or a “cellular” phone), and a computer with IoT terminals, such as fixed, portable, pocket, handheld, computer built-in, or vehicle mounted devices. For example, stations (STA), subscriber units, subscriber stations, mobile stations, mobiles, remote stations, access points, remote terminals, access terminals, user terminals, user agents, user devices or user equipment (UE). Alternatively, the user equipment 110 can also be a device for unmanned aerial vehicles. Alternatively, the user equipment 110 can also be an onboard device, such as a trip computer with wireless communication ability or wireless communication devices connected to an external trip computer. Alternatively, the user equipment 110 can also be a roadside device, such as a street light, a signal light, or other roadside devices with wireless communication ability.

The base station 120 can be a network side device in the wireless communication system. The wireless communication system can be the 4th generation (4G) mobile communication system, also known as Long Term Evolution (LTE) system. Alternatively, the wireless communication system can also be the 5th generation (5G) system, also known as New Radio system or 5G NR system. Alternatively, the wireless communication system can also be the next generation system following 5G system. The access network in 5G system can be referred to as the New Generation-Radio Access Network (NG-RAN).

The base station 120 can be the Evolved Node B (eNB) employed in 4G system. Alternatively, the base station 120 can also be the next Generation Node B (gNB) constructed in a centralized and distributed architecture in 5G system. When constructed in the centralized and distributed architecture, the base station 120 usually includes a central unit (CU) and at least two distributed units (DUs). The central unit is provided with a protocol stack consisting of the Packet Data Convergence Protocol (PDCP) layer, the Radio Link Control (RLC) layer, and the Medium Access Control (MAC) layer. The distributed unit is provided with a protocol stack of the Physical (PHY) layer. Specific implementations of the base station 120 are not limited in embodiments of the present disclosure.

A wireless connection can be established between the base station 120 and the user equipment 110 via a wireless air interface. In different implementations, the wireless air interface is based on the 4th generation (4G) mobile communication network technology standard. Alternatively, the wireless air interface is based on the 5th generation (5G) mobile communication network technology standard, for example, the wireless air interface is the New Radio. Alternatively, the wireless air interface can also be a wireless air interface based on the next generation mobile communication network technology standard following 5G.

In some embodiments, the E2E (End to End) connection can also be established between user equipment 110. For example, in the Vehicle to Everything (V2X) communication, there are scenes such as V2V (Vehicle to Vehicle) communication, V2I (Vehicle to Infrastructure) communication, and V2P (Vehicle to Pedestrian) communication.

In some embodiments, the above-mentioned user equipment can be considered as the terminal devices in the following embodiments.

Some of the base stations 120 are respectively connected to the network management device 130. The network management device 130 can be a core network device in the wireless communication system, for example, the network management device 130 can be the Mobility Management Entity (MME) in the Evolved Packet Core (EPC). Alternatively, the network management device can also be other core network devices, such as the Service GateWay (SGW), the Public Data Network GateWay (PGW), the Policy and Charging Rules Function (PCRF), or the Home Subscriber Server (HSS), etc. Implementations of the network management device 130 are not limited in embodiments of the present disclosure.

For the convenience of those skilled in the art to understand the present disclosure, one or more embodiments are listed in the present disclosure to clearly illustrate the technical solutions of the present disclosure. Those skilled in the art can understand that the one or more embodiments provided in the present disclosure can be implemented separately, combined with methods of other embodiments in the present disclosure, or implemented separately or in combination with some methods in other related art, and embodiments of the present disclosure do not limit this.

The mobile operator can play an important role in providing customers with integrated communication and sensing applications based on the 5G system (5GS). The integrated communication and sensing application includes the management and control of 5G based sensing services, for example, Infrastructure Assisted Environment Sensing, Infrastructure-Based Tele-Operated Driving, High-Definition Map Collection, and Sharing and Tele-Operated Driving Support.

The communication assisted sensing services that 5GS can provide include examples as follows.
1. Environmental real-time monitoring: wireless signals are used to reconstruct the environmental map, to further improve positioning accuracy, and enable environmental related applications, such as realizing an array of real-time monitoring related applications including dynamic 3D maps for driving assistance, pedestrian flow statistics, intrusion detection, traffic detection, etc.
2. Autonomous vehicle/UAV: autonomous vehicle/UAV applications have some common functional requirements. For example, autonomous vehicles/UAVs shall support Detection and Avoidance (DAA) to avoid obstacles. Meanwhile, autonomous vehicles/UAVs shall have the capability to monitor path information, like selecting routes, complying with traffic regulations.
3. Air pollution monitoring: the quality of the received wireless signal exhibits different attenuation characteristics with changes in air humidity, air particulate matter (PM) concentration, carrier frequency, etc., and can be used for weather or air quality detection.
4. Indoor healthcare and intrusion detection: the respiration rate estimation, breathing depth estimation, apnea detection, monitoring of vital signs in the elderly, and indoor intrusion detection can be realized.

Sensing of wireless communication channels and environment can further improve the performance of communication systems. The sensing assisted communication scenarios can include examples as follows.
5. Sensing the location and channel environment of the UE, to narrow the beam sweeping range and shorten the beam training time.
6. Sensing the position, velocity, motion trajectory, and channel environment of the UE for beam prediction, to reduce the overhead of beam measurement and the delay of beam tracking.
7. Sensing the property and channel environment of the UE, to improve the performance of channel estimation.

During a sensing procedure, the UE needs to obtain supports from the network side. The network side needs to inform the UE of which sensing services the network side can provide. Currently, there is no solution for the network side to inform the UE of which sensing services it can provide to the UE. For example, when the UE (such as a vehicle with 3GPP UE onboard) accesses the network, the solution of how the UE (vehicle) knows it can obtain the surrounding sensing information from the network is still not available yet.

Therefore, how the UE obtains from the network side the sensing service information that the network side can provide is an urgent problem.

As shown in FIG. 2, embodiments of the present disclosure provide an information processing method. The method is performed by the Access and Mobility Management Function (AMF), and includes following steps.

In step 201, request information sent by UE via a base station is received. In some embodiments, the request information is configured to request for sensing service capability information of a network side.

In some embodiments, the UE can be terminals such as mobile phones in the cellular mobile communication system. In some embodiments, the UE can be a communication device used to receive sensing information, and the base station can include the gNB, etc.

In some embodiments, the request information can be sent from the UE to the base station and the base station can forward the request information to the AMF.

In some embodiments, the sensing information can be information obtained through environmental sensing based on a sensing signal. The sensing information can include sensing raw data and/or a sensing result, etc.

In some embodiments, the sensing information can be the sensing signal itself.

The sensing signal can be the signal used for both data communication and environmental sensing in the cellular mobile communication system. The sensing signal may be disturbed by the surrounding environment during transmission, such as reflection, resulting in different changes. The UE perceives the surrounding environment based on the received sensing signal. The sensing signal can be radio frequency signals, including millimeter wave signals, terahertz signals, etc. The UE can also be used to transmit the sensing signal for other communication devices to receive and to perceive the surrounding environment. The sensing information can be determined by the network side during the sensing procedure. For example, the sensing information can be determined by the sensing service function in the core network.

The UE can send the request information to the network side to request for the sensing service capability information of the network side before performing the sensing.

In some embodiments, the sensing service capability of the network side can be the capability of the network side of providing the sensing information.

The sensing service capability information can include, but is not limited to, one of the following:
whether the network side can provide the sensing service for the UE;
an area where the network can provide the sensing service for the UE;
a type of the sensing service that the network side can provide for the UE; or
a time at which the network side can provide the sensing service for the UE.

In some embodiments, the UE can send the request information to the AMF.

In some embodiments, the request information can be carried in the Non-Access Stratum (NAS) message and sent to the AMF.

In some embodiments, the sensing service capability information of the network side includes sensing service capability information of the access network side and/or sensing service capability information of the core network side.

In some embodiments, the request information is a registration request message.

The UE can send the request information to the AMF during a registration procedure. The UE can send the registration request message, as a request message, to the AMF via the base station.

In this way, the UE can request from the AMF for the sensing service capability information of the network side by using the request information, thereby meeting the sensing needs of the UE and improving the reliability when the UE performs the sensing service.

In some embodiments, the request information includes at least one of the following:
a sensing data network name; or
an indicator for requesting for the sensing service capability information.

The UE can use different forms of request information to request for the sensing service capability information of the network side. In some embodiments, the UE can use one or more bits to carry the request information.

In some embodiments, the UE can carry the sensing data network name (DNN) in the registration request message, to request for the sensing service capability information of the network side. Different sensing data network names can be used to request for different sensing services. The sensing data network name can be used to request for the sensing service capability information of the network side corresponding to the sensing data network name.

In some embodiments, the UE can carry the indicator for requesting for the sensing service capability information in the registration request message. The indicator for requesting for the sensing service capability information can occupy one or more bits.

In some embodiments, the UE can send the registration request message to the AMF via the gNB. The registration request message can include a registration parameter, such as a registration type, SUCI (Subscription Concealed Identifier), 5G-GUTI (5G Globally Unique Temporary Identifier) or PEI (Permanent Equipment Identifier), a security parameter, etc. The registration request message can further include the sensing data network name and/or the indicator for requesting for the sensing service capability information, which is used to request for the sensing service capability information of the network side.

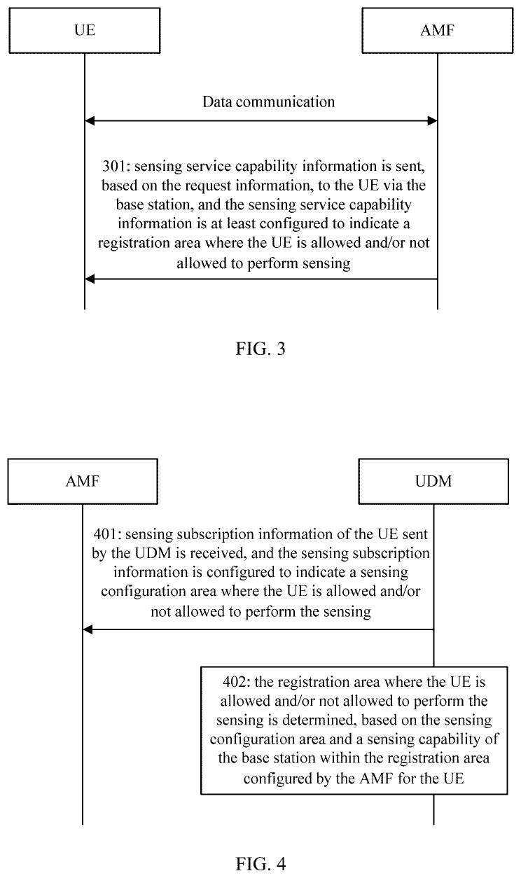

As shown in FIG. 3, embodiments of the present disclosure provide an information processing method. The method is performed by the AMF, and includes following steps.

In step 301, sensing service capability information is sent, based on the request information, to the UE via the base station. In some embodiments, the sensing service capability information is at least configured to indicate a registration area where the UE is allowed and/or not allowed to perform sensing.

The step 301 can be implemented separately or in combination with step 201.

In some embodiments, the AMF can send the sensing service capability information to the UE based on the request information, indicating that whether the network side can provide the sensing service for the UE, etc. The registration area can be the registration area of the UE authorized by the network side.

In some embodiments, the sensing service capability information can include the registration area where the UE is allowed to perform the sensing and/or the registration area where the UE is not allowed to perform the sensing.

In some embodiments, within the registration area where the UE is allowed to perform the sensing, the UE can receive the sensing information sent by the network side.

In some embodiments, within the registration area where the UE is not allowed to perform the sensing, the UE cannot receive the sensing information sent by the network side.

In some embodiments, the registration area indicated by the AMF can be pre-configured by the core network for the UE.

The registration area where the UE is allowed and/or not allowed to perform the sensing can be for all sensing services or for specific sensing services. In some embodiments, the registration area where the UE is allowed and/or not allowed to perform the sensing can be based on a specific sensing data network name.

In this way, the UE can obtain the sensing service capability information, thereby meeting the sensing needs of the UE and improving the reliability when the UE performs the sensing service.

In some embodiments, the registration area is an area taking a tracking area (TA) as a granularity.

The AMF can indicate to UE that the TA which is allowed for the sensing to be performed and/or the TA which is not allowed for the sensing to be performed. In some embodiments, the TA which is allowed for the sensing to be performed can include one or more TAs, and the TA which is not allowed for the sensing to be performed can include one or more TAs.

In some embodiments, the sensing service capability information is configured to indicate at least one TA and first network sensing-supported identification. The first network sensing-supported identification is configured to indicate that the UE is allowed to perform the sensing in the at least one TA.

In some embodiments, alternatively, the sensing service capability information is configured to indicate at least one TA and second network sensing-supported identification corresponding to each TA. The second network sensing-supported identification is configured to indicate whether the UE is allowed to perform the sensing in the TA corresponding to the second network sensing-supported identification.

The AMF can indicate N TAs to the UE, and use the first network sensing-supported identification to indicate that the UE is allowed to perform the sensing in the N TAs, where N is a positive integer greater than or equal to 1.

The AMF can indicate M TAs to the UE, and use M second network sensing-supported identification to indicate whether the UE is allowed to perform the sensing in each of the M TAs.

In some embodiments, sending the sensing service capability information to the UE via the base station includes: sending a registration accept message carrying the sensing service capability information to the UE via the base station.

The sensing service capability information can be carried by the AMF in the registration accept message and sent to the UE. The registration accept message can be sent from the AMF to the UE via the base station.

After authentication and authorization for the UE, the AMF sends the registration accept message to the UE to complete the registration of the UE. The registration accept message can include the 5G-GUTI and the registration area (the registration area where the sensing is allowed and/or not allowed).

In some embodiments, the registration accept message can carry a network supporting sensing indicator, which is configured to indicate that the network side can support the UE in performing the sensing service.

As shown in FIG. 4, embodiments of the present disclosure provide an information processing method. The method is performed by AMF, and includes following steps.

In step 401, sensing subscription information of the UE sent by the Unified Data Management Function (UDM) is received. The sensing subscription information is configured to indicate a sensing configuration area where the UE is allowed and/or not allowed to perform the sensing.

In step 402, the registration area where the UE is allowed and/or not allowed to perform the sensing is determined, based on the sensing configuration area and a sensing capability of the base station within the registration area configured by the AMF for the UE.

The steps 401 and 402 can be implemented separately or in combination with steps 201 and/or 301.

The core network can pre-configure the sensing configuration area for UE where the UE is allowed and/or not allowed to perform the sensing. The sensing subscription information configured to indicate the sensing configuration area where the UE is allowed and/or not allowed to perform the sensing can be stored in the UDM. After receiving the request information, the AMF can request, based on the identification information, etc. of the UE, from the UMD to send the sensing subscription information to the AMF.

The AMF can configure the registration area for the UE, and select within the registration area configured for UE, the registration area belonging to a range of the sensing configuration area where the UE is allowed to perform the sensing. Multiple base stations can exist within the registration area belonging to the range of the sensing configuration area where the sensing is allowed. Due to the fact that not all base stations in the registration area belonging to the range of the sensing configuration area may have sensing capabilities, the AMF will determine the registration area where the UE is allowed and/or not allowed to perform the sensing, based on the sensing capability of the base station in the registration area belonging to the range of the sensing configuration area where the sensing is allowed.

In some embodiments, the sensing capabilities of different base stations can be pre-configured in the AMF.

In some embodiments, a range of the sensing configuration area is greater than or equal to a range of the registration area configured by the AMF for the UE.

The sensing configuration area configured by the network side for the UE can have a larger area range. In some embodiments, the sensing configuration area can be a city area. The sensing configuration area can include multiple registration areas, for example, there can be multiple TAs within the sensing configuration area.

In some embodiments, the sensing configuration area can be an area taking a TA as a granularity.

The UMD can indicate the sensing configuration area to the AMF by taking the TA as the granularity. For example, the sensing configuration area can be composed of multiple TAs.

In some embodiments, the AMF can first configure a TA list for the UE. Then, the AMF can select the TA(s) in the TA list, and the selected TA(s) belong(s) to the sensing configuration area where the sensing is allowed. Finally, based on the capabilities of the base stations within the TAs included in the sensing configuration area where the sensing is allowed, the AMF determines the TA(s) within the sensing configuration area where the sensing is allowed, so that the TA(s) where the UE is allowed and/or not allowed to perform the sensing can be determined.

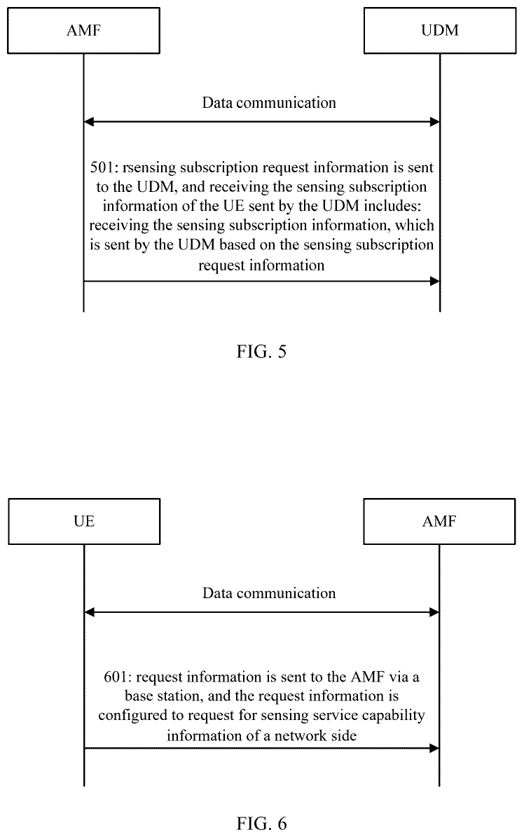

As shown in FIG. 5, embodiments of the present disclosure provide an information processing method. The method is performed by the AMF, and includes following steps.

In step 501, sensing subscription request information is sent to the UDM.

In some embodiments, receiving the sensing subscription information of the UE sent by the UDM includes: receiving the sensing subscription information, which is sent by the UDM based on the sensing subscription request information.

The step 501 can be implemented separately or in combination with steps 201, 301, 401, and/or 402.

The sensing subscription information indicating the sensing configuration area where the UE is allowed and/or not allowed to perform the sensing can be subscribed by the AMF from the UDM. The AMF can send the sensing subscription request information to the UDM, and request from the UDM for the sensing subscription information subscribed.

In some embodiments, the sensing subscription request information can be an indicator, for example, the sensing subscription request indication.

In some embodiments, the UE can send the registration request message carrying the request information to the AMF. After receiving the registration request message, the AMF can use the Nudm_SDM_Get to retrieve at least one of the following: Access and Mobility Subscription data, SMF (Session Management Function) Selection Subscription data, UE context in SMF data, and Location Service (LCS) mobile origination. The AMF can carry the sensing subscription request indication in the Nudm_SDM_Get sent to the UDM. The AMF establishes the UE context for the UE after obtaining the Access and Mobility Subscription data from the UDM. The Access and Mobility Subscription data can include the sensing subscription information in the UDM, namely an allowed sensing configuration area of the UE, where the UE can obtain the sensing information from the network within this sensing configuration area, and/or, a restricted sensing configuration area of the UE, where the sensing is not allowed to be performed, meaning that the UE cannot obtain the sensing information from the network within this sensing configuration area.

As shown in FIG. 6, embodiments of the present disclosure provide an information processing method. The method is performed by UE, and includes following steps.

In step 601, request information is sent to the AMF via a base station. In some embodiments, the request information is configured to request for sensing service capability information of a network side.

The UE can be terminals such as mobile phones in the cellular mobile communication system. In some embodiments, the UE can be a communication device used to receive sensing information, and the base station can include the gNB, etc.

In some embodiments, the request information can be sent from the UE to the base station and the base station can forward the request information to the AMF.

In some embodiments, the sensing information can be information obtained through environmental sensing based on a sensing signal. The sensing information can include sensing raw data and/or a sensing result, etc.

In some embodiments, the sensing information can be the sensing signal itself.

The sensing signal can be the signal used for both data communication and environmental sensing in the cellular mobile communication system. The sensing signal may be disturbed by the surrounding environment during transmission, such as reflection, resulting in different changes. The UE perceives the surrounding environment based on the received sensing signal. The sensing signal can be radio frequency signals, including millimeter wave signals, terahertz signals, etc. The UE can also transmit the sensing signal for other communication devices to receive and to perceive the surrounding environment. The sensing information can be determined by the network side during the sensing procedure. For example, the sensing information can be determined by the sensing service function in the core network.

The UE can send the request information to the network side to request for the sensing service capability information of the network side before performing the sensing.

In some embodiments, the sensing service capability of the network side can be the capability of the network side of providing the sensing information.

The sensing service capability information can include, but is not limited to, one of the following:
whether the network side can provide the sensing service for the UE;
an area where the network can provide the sensing service for the UE;
a type of the sensing service that the network side can provide for the UE; or
a time at which the network side can provide the sensing service for the UE.

In some embodiments, the UE can send the request information to the AMF.

In some embodiments, the request information can be carried in the NAS message and sent to the AMF.

In some embodiments, the sensing service capability information of the network side includes sensing service capability information of the access network side and/or sensing service capability information of the core network side.

In some embodiments, the request information is a registration request message.

The UE can send the request information to the AMF during a registration procedure. The UE can send the registration request message, as a request message, to the AMF via the base station.

In this way, the UE can request from the AMF for the sensing service capability information of the network side by using the request information, thereby meeting the sensing needs of the UE and improving the reliability when the UE performs the sensing service.

In some embodiments, the request information includes at least one of the following:
a sensing data network name; or
an indicator for requesting for the sensing service capability information.

The UE can use different forms of request information to request for the sensing service capability information of the network side. In some embodiments, the UE can use one or more bits to carry the request information.

In some embodiments, the UE can carry the sensing data network name (DNN) in the registration request message, to request for the sensing service capability information of the network side. Different sensing data network names can be used to request for different sensing services. The sensing data network name can be used to request for the sensing service capability information of the network side corresponding to the sensing data network name.

In some embodiments, the UE can carry the indicator for requesting for the sensing service capability information in the registration request message. The indicator for requesting for the sensing service capability information can occupy one or more bits.

In some embodiments, the UE can send the registration request message to the AMF via the gNB. The registration request message can include a registration parameter, such as a registration type, SUCI or 5G-GUTI or PEI, a security parameter, etc. The registration request message can further include the sensing data network name and/or the indicator for requesting for the sensing service capability information, which are used to request for the sensing service capability information of the network side.

As shown in FIG. 7, embodiments of the present disclosure provide an information processing method. The method is performed by UE, and includes following steps.

In step 701, sensing service capability information is received, the sensing service capability information being sent by the AMF to the UE via the base station based on the request information. In some embodiments, the sensing service capability information is at least configured to indicate a registration area where the UE is allowed and/or not allowed to perform sensing.

The step 701 can be implemented separately or in combination with step 601.

In some embodiments, the AMF can send the sensing service capability information to the UE based on the request information, indicating whether the network side can provide the sensing service for the UE, etc. The registration area can be the registration area of the UE authorized by the network side.

In some embodiments, the sensing service capability information can include the registration area where the UE is allowed to perform the sensing and/or the registration area where the UE is not allowed to perform the sensing.

In some embodiments, within the registration area where the UE is allowed to perform the sensing, the UE can receive the sensing information sent by the network side.

In some embodiments, within the registration area where the UE is not allowed to perform the sensing, the UE cannot receive the sensing information sent by the network side.

In some embodiments, the registration area indicated by the AMF can be pre-configured by the core network for the UE.

The registration area where the UE is allowed and/or not allowed to perform the sensing can be for all sensing services or for specific sensing services. In some embodiments, the registration area where the UE is allowed and/or not allowed to perform the sensing can be based on a specific sensing data network name.

In this way, the UE can obtain the sensing service capability information, thereby meeting the sensing needs of the UE and improving the reliability when the UE performs the sensing service.

In some embodiments, the registration area is an area taking a tracking area (TA) as a granularity.

The AMF can indicate to UE that the TA which is allowed for the sensing to be performed and/or the TA which is not allowed for the sensing to be performed. In some embodiments, the TA which is allowed for the sensing to be performed can include one or more TAs, and the TA which is not allowed for the sensing to be performed can include one or more TAs.

In some embodiments, the sensing service capability information is configured to indicate at least one TA and first network sensing-supported identification. The first network sensing-supported identification is configured to indicate that the UE is allowed to perform the sensing in the at least one TA.

In some embodiments, alternatively, the sensing service capability information is configured to indicate at least one TA and second network sensing-supported identification corresponding to each TA. The second network sensing-supported identification is configured to indicate whether the UE is allowed to perform the sensing in the TA corresponding to the second network sensing-supported identification.

The AMF can indicate N TAs to the UE, and use the first network sensing-supported identification to indicate that the UE is allowed to perform the sensing in the N TAs, where Nis a positive integer greater than or equal to 1.

The AMF can indicate M TAs to the UE, and use M second network sensing-supported identification to indicate whether the UE is allowed to perform the sensing in each of the M TAs.

In some embodiments, receiving the sensing service capability information, which is sent by the AMF to the UE via the base station based on the request information includes: receiving a registration accept message carrying the sensing service capability information, which is sent by the AMF via the base station.

The sensing service capability information can be carried by the AMF in the registration accept message and sent to the UE. The registration accept message can be sent from the AMF to the UE via the base station.

In some embodiments, the registration area where the UE is allowed and/or not allowed to perform the sensing is determined by the AMF based on the sensing configuration area where the UE is allowed and/or not allowed to perform the sensing and the sensing capability of the base station within the registration area configured by the AMF for the UE.

In some embodiments, the sensing configuration area is indicated by the sensing subscription information of the UE received by the AMF and sent by the Unified Data Management (UDM).

The core network can pre-configure the sensing configuration area for UE where the UE is allowed and/or not allowed to perform the sensing. The sensing subscription information configured to indicate the sensing configuration area where the UE is allowed and/or not allowed to perform the sensing can be stored in the UDM. After receiving the request information, the AMF can request, based on the identification information, etc. of the UE, from the UMD to send the sensing subscription information to the AMF.

The AMF can configure the registration area for the UE, and select within the registration area configured for UE, the registration area belonging to a range of the sensing configuration area where the UE is allowed to perform the sensing. Multiple base stations can exist within the registration area belonging to the range of the sensing configuration area where the sensing is allowed. Due to the fact that not all base stations in the registration area belonging to the range of the sensing configuration area may have sensing capabilities, the AMF will determine the registration area where the UE is allowed and/or not allowed to perform the sensing, based on the sensing capability of the base station in the registration area belonging to the range of the sensing configuration area where the sensing is allowed.

In some embodiments, the sensing capabilities of different base stations can be pre-configured in the AMF.

In some embodiments, a range of the sensing configuration area is greater than or equal to a range of the registration area configured by the AMF for the UE.

The sensing configuration area configured by the network side for the UE can have a larger area range. In some embodiments, the sensing configuration area can be a city area. The sensing configuration area can include multiple registration areas, for example, there can be multiple TAs within the sensing configuration area.

In some embodiments, the sensing configuration area can be an area taking a TA as a granularity.

The UMD can indicate the sensing configuration area to the AMF by taking the TA as the granularity. For example, the sensing configuration area can be composed of multiple TAs.

In some embodiments, firstly, the AMF can configure a TA list for the UE. Then the AMF can select the TA(s) in the TA list, and the selected TA(s) belong(s) to the sensing configuration area where the sensing is allowed. Finally, based on the capabilities of the base stations within the TAs included in the sensing configuration area where the sensing is allowed, the AMF determines the TA(s) within the sensing configuration area where the sensing is allowed, so that the TA(s) where the UE is allowed and/or not allowed to perform the sensing can be determined.

The sensing subscription information indicating the sensing configuration area where the UE is allowed and/or not allowed to perform the sensing can be subscribed by the AMF from the UDM. The AMF can send the sensing subscription request information to the UDM, and request from the UDM for the sensing subscription information subscribed.

In some embodiments, the sensing subscription request information can be an indicator, for example, the sensing subscription request indication.

In some embodiments, the UE can send the registration request message carrying the request information to the AMF. After receiving the registration request message, the AMF can use the Nudm_SDM_Get to retrieve at least one of the following: Access and Mobility Subscription data, SMF Selection Subscription data, UE context in SMF data, and Location Service (LCS) mobile origination. The AMF can carry the sensing subscription request indication in the Nudm_SDM_Get sent to the UDM. The AMF establishes the UE context for the UE after obtaining the Access and Mobility Subscription data from the UDM. The Access and Mobility Subscription data can include the sensing subscription information in the UDM, namely an allowed sensing configuration area of the UE, where the UE can obtain the sensing information from the network within this sensing configuration area, and/or, a restricted sensing configuration area of the UE, where the sensing is not allowed to be performed, meaning that the UE cannot obtain the sensing information from the network within this sensing configuration area.

In order to further explain embodiments of the present disclosure, a specific embodiment will be provided in the following.

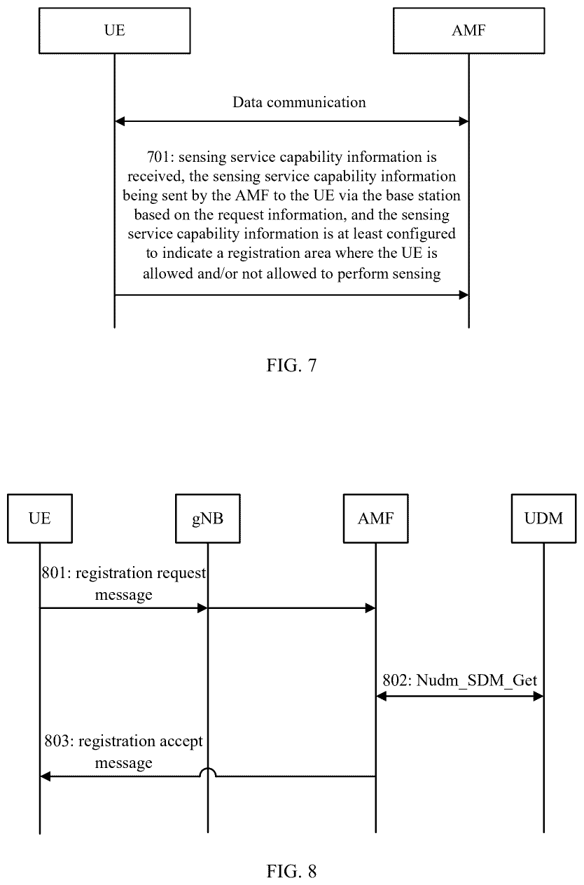

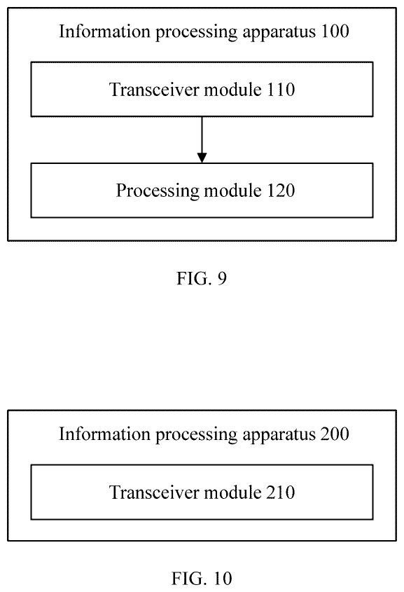

The specific steps for the UE to request for the sensing service capability information of the network side during the registration procedure of the UE include following steps, as shown in FIG. 8.

In step 801, the UE can send the registration request message to the AMF via the gNB. In some embodiments, the registration request message can include a registration parameter, such as a registration type, SUCI or 5G-GUTI or PEI, a security parameter, etc. The registration request message can further include the sensing data network name and/or the indicator for requesting for the sensing service capability information, which are used to request for the sensing service capability information of the network side.

In step 802, the AMF can use the Nudm_SDM_Get to retrieve at least one of the following: Access and Mobility Subscription data, SMF Selection Subscription data, UE context in SMF data, and Location Service (LCS) mobile origination. The AMF can carry the sensing subscription request indication in the Nudm_SDM_Get sent to the UDM. The AMF establishes the UE context for the UE after obtaining the Access and Mobility Subscription data from the UDM. The Access and Mobility Subscription data can include the sensing subscription information in the UDM:
an allowed sensing area of the UE, where the UE can obtain the sensing information from the network within this sensing configuration area; and/or
a restricted sensing area of the UE (the sensing configuration area where the sensing is not allowed to be performed), where the UE cannot obtain the sensing information from the network within this sensing configuration area.

In step 803, after authentication and authorization for the UE, the AMF sends the registration accept message to the UE to complete the registration of the UE. The registration accept message can include the 5G-GUTI and the registration area (the registration area where the sensing is allowed and/or not allowed). In order to set the tracking area (TAs) for the registration area, the AMF should consider the allowed sensing area of the UE (the sensing configuration area where the sensing is allowed to be performed) and restricted sensing area of the UE (the sensing configuration area where the sensing is not allowed to be performed), as well as the sensing capability of the gNB in the TA pre-configured in the AMF. The UE can obtain the sensing information from the network in the tracking area (TA) of the registration area where the sensing is allowed to be performed.

As shown in FIG. 9, embodiments of the present provide an information processing apparatus 100. The information processing apparatus 100 is applied to the AMF, and includes a transceiver module 110.

The transceiver module 110 is configured to receive request information sent by user equipment (UE) via a base station, with the request information being configured to request for sensing service capability information of a network side.

In some embodiments, the transceiver module 110 is further configured to send, based on the request information, the sensing service capability information to the UE via the base station, with the sensing service capability information being at least configured to indicate a registration area where the UE is allowed and/or not allowed to perform sensing.

In some embodiments, the registration area is an area taking a tracking area (TA) as a granularity.

In some embodiments, the sensing service capability information is configured to indicate at least one TA and first network sensing-supported identification, and the first network sensing-supported identification is configured to indicate that the UE is allowed to perform sensing in at least one TA.

In some embodiments, alternatively, the sensing service capability information is configured to indicate at least one TA and second network sensing-supported identification corresponding to each TA, and the second network sensing-supported identification is configured to indicate whether the UE is allowed to perform sensing in the TA corresponding to the second network sensing-supported identification.

In some embodiments, the transceiver module 110 is further configured to receive sensing subscription information of the UE sent by a Unified Data Management Function (UDM), with the sensing subscription information being configured to indicate a sensing configuration area where the UE is allowed and/or not allowed to perform sensing.

The apparatus further includes a processing module 120, and the processing module 120 is configured to determine, based on the sensing configuration area and a sensing capability of the base station within the registration area configured by the AMF for the UE, the registration area where the UE is allowed and/or not allowed to perform sensing.

In some embodiments, a range of the sensing configuration area is greater than or equal to a range of the registration area configured by the AMF for the UE.

In some embodiments, the transceiver module is further configured to send sensing subscription request information to the UDM.

In some embodiments, the transceiver module is specifically configured to receive the sensing subscription information sent by the UDM based on the sensing subscription request information.

In some embodiments, the transceiver module 110 is specifically configured to send a registration accept message carrying the sensing service capability information to the UE via the base station.

In some embodiments, the request information is a registration request message.

In some embodiments, the request information includes at least one of the following:
a sensing data network name; or
an indicator for requesting for the sensing service capability information.

As shown in FIG. 10, embodiments of the present provide an information processing apparatus 200. The information processing apparatus 200 is applied to the UE, and includes a transceiver module 210.

The transceiver module 210 is configured to send request information to an Access and Mobility Management Function (AMF) via a base station, with the request information being configured to request for sensing service capability information of a network side.

In some embodiments, the transceiver module 210 is further configured to receive the sensing service capability information sent, based on the request information, by the AMF to the UE via the base station, with the sensing service capability information being at least configured to indicate a registration area where the UE is allowed and/or not allowed to perform sensing.

In some embodiments, the registration area is an area taking a tracking area (TA) as a granularity.

In some embodiments, the sensing service capability information is configured to indicate at least one TA and first network sensing-supported identification, and the first network sensing-supported identification is configured to indicate that the UE is allowed to perform sensing in at least one TA.

In some embodiments, alternatively, the sensing service capability information is configured to indicate at least one TA and second network sensing-supported identification corresponding to each TA, and the second network sensing-supported identification is configured to indicate whether the UE is allowed to perform sensing in the TA corresponding to the second network sensing-supported identification.

In some embodiments, the registration area where the UE is allowed and/or not allowed to perform sensing is determined by the AMF based on a sensing configuration area where the UE is allowed and/or not allowed to perform sensing and a sensing capability of the base station within the registration area configured by the AMF for the UE.

In some embodiments, the sensing configuration area is indicated by sensing subscription information of the UE received by the AMF and sent by a Unified Data Management Function (UDM).

In some embodiments, a range of the sensing configuration area is greater than or equal to a range of the registration area configured by the AMF for the UE.

In some embodiments, the transceiver module 210 is specifically configured to receive registration accept message carrying the sensing service capability information sent by the AMF via the base station.

In some embodiments, the request information is a registration request message.

In some embodiments, the request information includes at least one of the following:
a sensing data network name; or
an indicator for requesting for the sensing service capability information.

It should be noted that those skilled in the art can understand that the apparatus provided in embodiments of the present disclosure can be used separately or together with some apparatus in embodiments of the present disclosure or in the related art.

The specific ways in which each module of the apparatus provided in the above embodiments performs operations have been described in detail in the relevant method embodiments, and will not be elaborated here.

Embodiments of the present disclosure provide a communication device including a processor and a memory for storing executable instructions for the processor.

In some embodiments, the processor is configured to run the executable instructions to cause the information processing method described in any of the embodiments of the present disclosure to be implemented.

In some embodiments, the communication device can include, but is not limited to, at least one of the UE or the network device. The network device here can include the core network device or the access network device, etc. In some embodiments, the access network device can include the base station. The core network can include the AMF and/or the SMF.

In some embodiments, the processor can include various types of storage media. The storage media are non-transitory computer storage media that can continue to remember and store information on the user equipment after the user equipment loses power.

The processor can be connected to the memory through a bus or other means for reading executable programs stored on the memory, such as for implementing at least one of the methods shown in FIGS. 2 to 8.

Embodiments of the present disclosure also provide a computer storage medium, which stores a computer executable program. When the computer executable program is executed by a processor, the method for determining the AI model described in any of the embodiments of the present disclosure is caused to be implemented, for example, at least one of the methods shown in FIGS. 2 to 8.

Regarding the devices or the storage media in the above embodiments, the specific ways in which each module performs operations have been described in detail in the relevant method embodiments, and will not be elaborated here.

FIG. 11 is a block diagram of user equipment 3000 according to embodiments of the present disclosure. For example, the user equipment 3000 can be a mobile phone, a computer, a digital broadcasting user device, a messaging device, a game console, a tablet device, a medical device, a fitness device, a personal digital assistant, etc.

Referring to FIG. 11, the user equipment 3000 can include at least one of the following components: a processing component 3002, a memory 3004, a power component 3006, a multimedia component 3008, an audio component 3010, an input/output (I/O) interface 3012, a sensor component 3014, and a communication component 3016.

The processing component 3002 typically controls the overall operation of the user equipment 3000, such as operations associated with display, telephone call, data communication, camera operation, and recording operations. The processing component 3002 may include one or more processors to execute instructions to complete all or part of the methods described above. In addition, the processing component 3002 may include one or more modules to facilitate interactions between the processing component 3002 and other components. For example, the processing component 3002 may include a multimedia module to facilitate the interaction between the multimedia component 3008 and the processing component 3002.

The memory 3004 is configured to store various types of data to support operations on the user equipment 3000. Examples of such data include instructions, contact data, phone book data, messages, pictures, videos, and the like for any application or method operating on the user equipment 3000. The memory 3004 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The power component 3006 provides power for various components of the user equipment 3000. The power component 3006 can include a power management system, one or more power supplies, and other components associated with generating, managing, and distributing power for the user equipment 3000.

The multimedia component 3008 includes a display screen providing an output interface between the user equipment 3000 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some embodiments, the multimedia component 3008 includes a front camera and/or a rear camera. When the user equipment 3000 is in operation mode, such as shooting mode or video mode, the front camera and/or rear camera can receive external multimedia data. Each front camera and rear camera can be a fixed optical lens system or have focal length and optical zoom capability.

The audio component 3010 is configured to output and/or input audio signals. For example, the audio component 3010 includes a microphone (MIC), which is configured to receive an external audio signal when the user equipment 3000 is in an operation mode, such as a calling mode, a recording mode, and a voice recognition mode. The received audio signal may be further stored in memory 3004 or transmitted via communication component 3016. In some embodiments, the audio component 3010 also includes a speaker for outputting audio signals.

The I/O interface 3012 provides an interface between the processing component 3002 and peripheral interface modules, which can be a keyboard, click wheel, button, etc. These buttons may include, but are not limited to, the Home button, Volume button, Start button, and Lock button.

The sensor component 3014 includes one or more sensors for providing various aspects of condition evaluation for the user equipment 3000. For example, the sensor component 3014 can detect an open/closed state of the user equipment 3000, relative positioning of the components. The component is, for example, a display and a keypad of the user equipment 3000. The sensor component 3014 can also detect changes in the position of the user equipment 3000 or one component of the user equipment 3000, presence or absence of the user's contact with the user equipment 3000, orientation or acceleration/deceleration of the user equipment 3000 and temperature change of the user equipment 3000. The sensor component 3014 may include a proximity sensor configured to detect the presence of nearby objects without any physical contact. The sensor component 3014 may also include a light sensor, such as a CMOS or CCD image sensor, for use in imaging applications. In some embodiments, the sensor component 3014 may also include an acceleration sensor, a gyroscope sensor, a magnetic sensor, a pressure sensor, or a temperature sensor.

The communication component 3016 is configured to facilitate wired or wireless communication between the user equipment 3000 and other devices. The user equipment 3000 can access wireless networks based on communication standards, such as WiFi, 4G or 5G, or a combination thereof. In some embodiments, the communication component 3016 receives a broadcast signal or broadcast related information from an external broadcast management system via a broadcast channel. In some embodiments, the communication component 3016 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some embodiments, the user equipment 3000 can be implemented through one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for implementing above methods.

In some embodiments, a non-transitory computer-readable storage medium including instructions is also provided, such as a memory 3004 including instructions, which can be executed by the processor 820 of the user equipment 3000 to complete above methods. For example, the non-transitory computer-readable storage medium can be ROM, random access memory (RAM), CD-ROM, tapes, floppy disks, optical data storage devices, etc.

As shown in FIG. 10, embodiments of the present disclosure provide a structure of a base station. In some embodiments, the base station 900 can be provided as a network-side device. As shown in FIG. 10, the base station 900 includes a processing component 922, which further includes one or more processors, as well as memory resources represented by the memory 932, for storing instructions that can be executed by the processing component 922, such as application programs. The application program stored in the memory 932 can include one or more modules each corresponding to a set of instructions. In addition, the processing component 922 is configured to execute instructions to perform any of the methods previously applied to the base station.

The base station 900 can also include a power component 926 configured to perform power management for the base station 900, a wired or wireless network interface 950 configured to connect the base station 900 to the network, and an input/output (I/O) interface 958. The base station 900 can operate operating systems stored on memory 932, such as Windows Server TM, Mac OS X™, Unix™, Linux™, FreeBSD™, or similar.

After considering the specification and practices of the invention disclosed herein, those skilled in the art will easily come up with other implementation solutions of the present disclosure. The present disclosure intends to cover any variations, uses, or adaptive changes of the present disclosure, which follow the general principles of the present disclosure and include common knowledge or commonly used technical means in the art that are not disclosed in the present disclosure. The specification and embodiments are only considered as exemplary, and the true scope and spirit of the present disclosure are defined by appended claims.

It should be understood that embodiments of the present disclosure are not limited to the precise structure described in the above and shown in the drawings, and various modifications and changes can be made without departing from its scope. The scope of the present disclosure is limited only by the appended claims.

1. An information processing method, performed by an Access and Mobility Management Function (AMF), the method comprising:
receiving request information sent by user equipment (UE) via a base station, wherein the request information is configured to request for sensing service capability information of a network side.

2. The method according to claim 1, further comprising:
sending, based on the request information, the sensing service capability information to the UE via the base station, wherein the sensing service capability information is at least configured to indicate at least one of a registration area where the UE is allowed to perform sensing, or a registration area where the UE is not allowed to perform sensing.

3. The method according to claim 2, wherein the registration area is an area taking a tracking area (TA) as a granularity.

4. The method according to claim 3, wherein the sensing service capability information is configured to indicate one of:
at least one TA and first network sensing-supported identification, wherein the first network sensing-supported identification is configured to indicate that the UE is allowed to perform sensing in the at least one TA; or
at least one TA and second network sensing-supported identification corresponding to each TA, wherein the second network sensing-supported identification is configured to indicate whether the UE is allowed to perform sensing in the TA corresponding to the second network sensing-supported identification.

5. The method according to claim 2, further comprising:
receiving sensing subscription information of the UE sent by a Unified Data Management Function (UDM), wherein the sensing subscription information is configured to indicate at least one of a sensing configuration area where the UE is allowed to perform sensing, or a sensing configuration area where the UE is not allowed to perform sensing; and
determining, based on the sensing configuration area and a sensing capability of the base station within the registration area configured by the AMF for the UE, at least one of the registration area where the UE is allowed to perform sensing, or the registration area where the UE is not allowed to perform sensing.

6. The method according to claim 5, wherein a range of the sensing configuration area is greater than or equal to a range of the registration area configured by the AMF for the UE.

7. The method according to claim 5, further comprising:
sending sensing subscription request information to the UDM;
wherein receiving the sensing subscription information of the UE sent by the UDM comprises:
receiving the sensing subscription information sent by the UDM based on the sensing subscription request information.

8. The method according to claim 2, wherein sending the sensing service capability information to the UE via the base station, comprises:
sending a registration accept message carrying the sensing service capability information to the UE via the base station.

9. The method according to claim 1, wherein the request information comprises at least one of:
a registration request message;
a sensing data network name; or
an indicator for requesting for the sensing service capability information.

10. (canceled)

11. An information processing method, performed by user equipment (UE), the method comprising:
sending request information to an Access and Mobility Management Function (AMF) via a base station, wherein the request information is configured to request for sensing service capability information of a network side.

12. The method according to claim 11, further comprising:
receiving the sensing service capability information sent, based on the request information, by the AMF to the UE via the base station, wherein the sensing service capability information is at least configured to indicate at least one of a registration area where the UE is allowed to perform sensing-and/or, or a registration area where the UE is not allowed to perform sensing.

13. The method according to claim 12, wherein the registration area is an area taking a tracking area (TA) as a granularity.

14. The method according to claim 13, wherein the sensing service capability information is configured to indicate one of:
at least one TA and first network sensing-supported identification, wherein the first network sensing-supported identification is configured to indicate that the UE is allowed to perform sensing in the at least one TA; or
at least one TA and second network sensing-supported identification corresponding to each TA, wherein the second network sensing-supported identification is configured to indicate whether the UE is allowed to perform sensing in the TA corresponding to the second network sensing-supported identification.

15. The method according to claim 12, wherein at least one of the registration area where the UE is allowed to perform sensing, or the registration area where the UE is not allowed to perform sensing is determined by the AMF based on at least one of a sensing configuration area where the UE is allowed to perform sensing, or a sensing configuration area where the UE is not allowed to perform sensing, and a sensing capability of the base station within the registration area configured by the AMF for the UE;
wherein the sensing configuration area is indicated by sensing subscription information of the UE received by the AMF and sent by a Unified Data Management Function (UDM).

16. The method according to claim 15, wherein a range of the sensing configuration area is greater than or equal to a range of the registration area configured by the AMF for the UE.

17. The method according to claim 12, wherein receiving the sensing service capability information sent, based on the request information, by the AMF to the UE via the base station, comprises:
receiving registration accept message carrying the sensing service capability information sent by the AMF via the base station.

18. The method according to claim 11, wherein the request information comprises at least one of:
a registration request message;
a sensing data network name; or
an indicator for requesting for the sensing service capability information.

19-21. (canceled)

22. A communication device, comprising:
a memory for storing executable instructions; and
one or more processors communicatively coupled to the memory,
wherein the executable instructions when collectively executed by the one or more processors cause the communication device to:
receive request information sent by user equipment (UE) via a base station, wherein the request information is configured to request for sensing service capability information of a network side.

23. A non-transitory computer storage medium having a computer executable program stored thereon, which when executed by a processor of the AMF, cause the AMF to perform the method according to claim 1.

24. A communication device, comprising:
a memory for storing executable instructions; and
one or more processors communicatively coupled to the memory,
wherein the executable instructions when collectively executed by the one or more processors cause the communication device to perform the method according to claim 11.
